(19) United States
(12) Patent Application Publication
(10) Pub. No.: US 2006/0013138 A1
(43) Pub. Date: Jan. 19, 2006

(54) Method and apparatus for dynamic bandwidth allocation in an ethernet passive optical network

(76) Inventors: Onn Haran, San Jose, CA (US); Ariel Maislos, Sunnyvale, CA (US); Nadav Aharony, Haifa (IL)

Correspondence Address: Mark Friedman;Bill Polkinghorn, 9003 Florin Way, Upper Marlboro, MD, 20772, US

(21) Appl. No.: 10/530,221

(22) PCT Filed: May 19, 2004
(86) PCT No.: PCT/IL04/00426

§ 371 Date: May 18, 2005

Related U.S. Application Data
(60) Provisional application No. 60/472,136, filed on May 21, 2003.

(51) Int. Cl. G01R 31/08; H04B 1/44; H04J 3/02

(52) U.S. Cl. 370/236; 370/282; 370/462

(57) ABSTRACT

In a passive optical network that includes a plurality of optical network units (ONUs) coupled to an optical line terminal (OLT), dynamic bandwidth allocation (DBA) methods and algorithms designed to support a short delay as well as best effort services, while maintaining fairness between subscribers. In a preferred embodiment, a DBA allocation method comprises the steps of calibrating requests issued by each of the ONUs to obtain respective calibrated requests, allocating a bandwidth amount to each ONU based on the calibrated requests using an allocation scheme selected from the group consisting of an under-utilization allocation scheme and an over-utilization allocation scheme, and based on the bandwidth allocation, granting the ONUs a second plurality of constant delay grants per each cycle.

### FIELD OF THE INVENTION

The present invention relates generally to data access methods, and more particularly, to methods for optimizing uplink data transmission in Ethernet packet traffic over Passive Optical Network (PON) topologies.

### BACKGROUND OF THE INVENTION

The Ethernet PON (EPON) is using 1 gigabit per second Ethernet transport, which is suitable for very high-speed data applications, as well as for converged system support (telephone, video, etc.). The unprecedented amount of bandwidth is directed toward, and arriving from a single entity, the Optical Network Unit (ONU).

An Optical Line Terminal (OLT) manages remotely the transmission of each ONU. The OLT and the ONUs exchange messages. In each cycle of such an exchange, the OLT grants a grant to each ONU, which is answered by a report message from the ONU. The ONU has a queue manager that prepares queue status information, which is transmitted using Multipoint Control Protocol (MPCP) messages to the OLT to enable smart management. In other words, the ONU “informs its internal queues status” to the OLT. The OLT management is executed using a Dynamic Bandwidth Allocation (DBA) algorithm. An efficient algorithm is essential to guarantee Quality of Service (QoS), required to fulfill a Service Level Agreement (SLA). Operator revenues will increase from selling sophisticated SLAs to customers. High bandwidth utilization allows adding more customers to the network. Thus, an efficient DBA algorithm is an enabler to operator revenues.

Ethernet as a packet protocol is not designed to guarantee transfer delay and jitter. While it is sufficient for data transfer, it lacks the ability to support Time Division Multiplexed (TDM) channels. The jitter/delay requirements cannot be met unless data a packet contains a small amount of samples. Moreover, considering that an ONU can transmit only when commanded by an OLT, and not burst when data is available, makes it more complex to support TDM traffic in the uplink. Utilizing Ethernet in the access requires supporting such requirements in order to meet user requirements.

When the uplink is overutilized, fairness determines the variance from the SLAs fulfillment for all ONUs. The variance needs to be measured upon all ONUs, as a case in which the SLA of one ONU is badly deprived and all the rest are fulfilled is considered unfair. Some sort of metric is used to combine all parameters (delay, bandwidth, jitter, etc.) to yield an error value. Fairness is measured over a period of time. The measurement becomes more accurate as the period is shortened. High fairness is required to guarantee customer satisfaction under heavy loads.

Fragmentation loss is the amount of wasted grant time that is not utilized for packet transmission. The subject is explained in detail in PCT application PCT IL03/00702 by Onn Haran et al. filed 26 Aug. 2003, and titled “Methods for dynamic bandwidth allocation and queue management in Ethernet Passive Optical Networks”, which is incorporated herein by reference.

The reason for fragmentation is lack of synchronization between the ONU queue status and the OLT knowledge of queue status. When this happens, the fragmentation can result in empty grant transmission, when the pending packets are larger than the given grant. This effect increases the transmission delay.

FIG. 1 shows a prior art EPON system, comprising an OLT 100 and a plurality of ONUs 102. The OLT and the ONUs exchange messages. In each cycle of such an exchange, the OLT grants a grant G to an ONU, which is answered by a report message REP from the ONU to the OLT. For example, the reporting by the ONU to a grant received in a cycle N-1 at a grant message time t_{G(N-1)} occurs at a report message transmission time t_{R(n-1)}. Regardless of the particular algorithm be used to differentiate between ONUs, the basic granting scheme is identical. The information of the OLT is updated only up to t_{R}(N-1). The subject is explained in more detail in a related PCT application, PCT IL03/00702 filed 26 Aug. 2003, which is incorporated herein by reference.

The methods used in prior art result in a lack of tight jitter/delay guarantee, low fairness and potentially complete grant loss, and consequently in low bandwidth utilization and high transfer delay. It is thus desirable to provide a new set of efficient management methods and algorithms that will enable tight jitter/delay guarantee, allow high fairness, and eliminate complete grant loss.

### SUMMARY OF THE INVENTION

The present invention discloses various embodiments of DBA methods and algorithms. The algorithm receives the status of each ONU (number of bytes pending transmission), conveyed in “Report” messages. Using the information from the report messages, and according to the SLA, the OLT decides the amount of bandwidth to be received by each ONU, and its location on the timeline. The OLT then informs each ONU when the ONU is allowed to transmit, using GATE messages.

In a preferred embodiment, a DBA method according to the present invention comprises three main steps/stages: a) a “request calibration” step/stage, which adjusts an ONU request based on SLA and history. Each report is adjusted regardless of the report values from the other ONUs. b) a “bandwidth allocation” step/stage, during which the amount of bandwidth granted to each ONU is decided. The bandwidth allocation is based on the requests from all the ONUs, and the allocation includes a specific amount to each ONU. The fairness between ONUs is maintained. c) a “grant placement” step/stage, which assigns the grant over the time axis (timeline) to meet the timing requirement set by the SLA, namely jitter and delay for time critical services.

According to the present invention there is provided a method for dynamic bandwidth allocation in a passive optical network that includes a plurality of ONUs coupled to an OLT, the method comprising the steps of: by the OLT, in each given cycle: calibrating requests issued by each of the ONUs to obtain respective calibrated requests; allocating a bandwidth amount to each ONU based on the calibrated requests using an allocation scheme selected from the group consisting of an under-utilization allocation scheme and an over-utilization allocation scheme; and, based on the bandwidth allocation, granting the ONUs a second plurality of constant delay grants per each cycle, whereby the granting facilitates a tight jitter/delay guarantee and high fairness and eliminates grant loss.

According to the present invention there is provided in an Ethernet passive optical network a method for dynamically allocating bandwidth to a plurality of ONUs that are granted grants by an OLT in response to requests, the method comprising the steps of: per each grant cycle, responsive to the ONU, determining an uplink utilization state that includes a state selected from the group of under-utilization and over-utilization; and running independently a bandwidth allocation scheme correlated with the uplink utilization state, the bandwidth allocation scheme selected from the group of respectively an under-utilization allocation scheme and an over-utilization allocation scheme.

According to the present invention there is provided, in an Ethernet passive optical network that includes a plurality of ONUs interacting with an OLT, a method for dynamically allocating bandwidth by the OLT to the ONUs in an under-utilization state of a cycle, comprising the steps of determining the respective importance of each ONU, and allocating bandwidth based on the respective importance of each ONU.

Within the context of the present invention, “importance” also includes “precedence”, “priority”, etc. In addition to the specific way of indicating “importance” discussed below, importance may be also indicated by different SLA parameters, for example minimal bandwidth and maximal bandwidth. Therefore, the term “importance” as used herein is meant to embrace all these terms and their equivalents.

### BRIEF DESCRIPTION OF THE DRAWINGS

The invention is herein described, by way of example only, with reference to the accompanying drawings, wherein:

FIG. 1 shows schematically a prior art method for controlling messages flow between an OLT and an ONU;

FIG. 2 shows a flow chart of the main stages in the algorithm of the present invention;

FIG. 3 is a flow chart of the request calibration process, which adjusts an ONU request bases on SLA and history;

FIG. 4 shows schematically a timing relation of a control message between an OLT and an ONU;

FIG. 5 is a flow chart of bandwidth allocation, during which the amount of bandwidth granted to each ONU is decided;

FIG. 6 shows an exemplary calibration procedure for an ONU in case of under-utilization;

FIG. 7 is a flow chart of grant placement, which assigns the grant over the time axis.

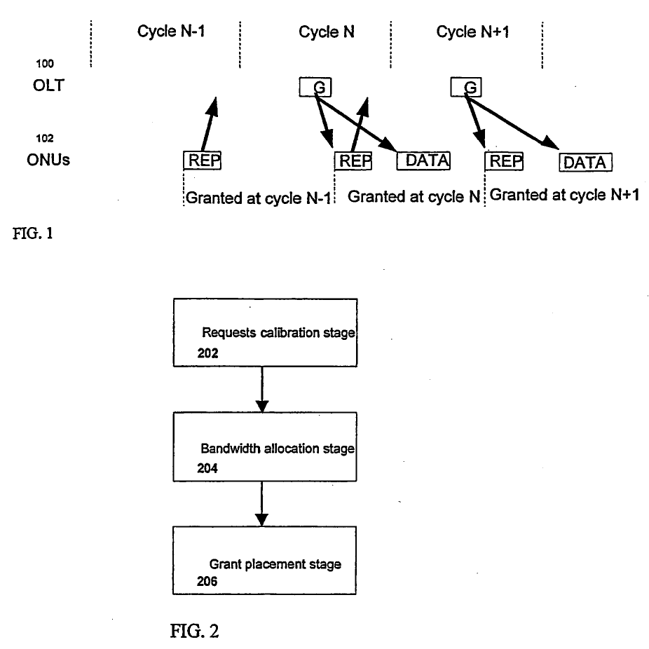

### DESCRIPTION OF THE PREFERRED EMBODIMENTS

The present invention provides, in various embodiments, a method for building an efficient dynamic bandwidth allocation algorithm, based on three main stages (or method steps) shown in FIG. 2: a requests calibration stage 202, a bandwidth allocation stage 204, and a grant placement stage 206. The combination of these stages/steps yields a solution that solves the problems existing in prior art, i.e. enable tight jitter/delay guarantee, allow high fairness, and eliminate complete grant loss. These embodiments are now described in detail below.

Request Calibration Stage/Step 202

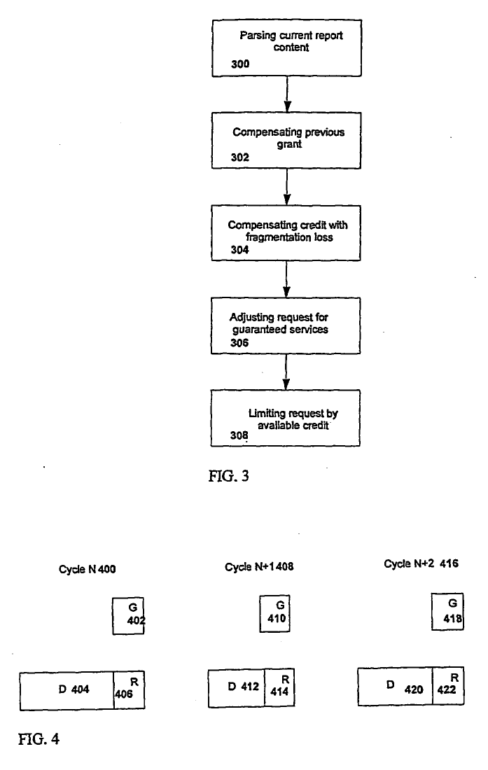

Request calibration step 202 adjusts the requests issued by an ONU. This stage includes preferably 5 sub-steps shown in FIG. 3: a parsing current report content step 300, a queue occupancy estimation step 302, a compensating credit with fragmentation loss step 304, an adjusting request for guaranteed service step 306 and a limiting request by available credit step 308.

The ONU report message is parsed in step 300. The report message may contain up to 8 different amounts of pending bytes, one per each priority. In this step, the pending bytes from different priorities may be summed to reduce the amount of information handled by the method (algorithm).

Queue occupancy estimation step 302 updates the report based on the grants given in the immediately preceding cycle. Without this predictor (compensation process) the requests will not be accurate, as depicted in FIG. 4. FIG. 4 shows schematically a timing relation of a control message between an OLT and an ONU. A grant message G410, transmitted (issued) in a cycle N+1 (marked as 408), is based on a report message R406 transmitted in a cycle N (marked as 400). Report message R406 contains data that was partially handled by grant message G402 issued in cycle 400 (N). So any grant, for example grant G410 in cycle N+1 (408), needs to take into account the amount of data granted in the immediately preceding grant (402 in this example). In other words, grant G410 may need to grant less space than requested by R406, since some of the data of R406 was handled in the previous grant.

Returning now to FIG. 3, the amount of bytes pending for transmission is read from the report message in step 300, and is denoted as the “requested amount” of bytes. The algorithm decreases the ONU request based on the previous grant. If the DBA predicted the amount of data granted from each specific priority, then the values from the report message need to be decreased separately for each priority. In any case, the adjusted request value cannot be negative, and has to be set to 0 in the case the previous grant was higher than the current queue occupancy.

In summary, the amount of bytes pending in the ONU queue is estimated by the OLT on the basis of the received report and on the grant history. The report contains also the number of bytes that are expected to leave the ONU in the cycle used for the SW processing, and these bytes are reduced from the ONU request.

The process in compensating credit with fragmentation loss step 304 is a process that compares the actual transmitted number of bytes with the granted number of bytes in the respective cycle. Each ONU has a limit number for the average number of bytes it may transmit The accounting of bytes is maintained using credit If an ONU transmitted less than the granted amount then it should not be accounted for that, and the value of the unused portion of the grant is returned to its credit. Step 304 requires a delay of two cycles. Using the same example of FIG. 4, then only at cycle N+2, marked as 416, the measurement is available for the grant given by message 410, during cycle 408.

As an example for queue occupancy estimation, let us assume an ONU that reports 20000 bytes in cycle 1, and was not granted in the previous cycle. This means that 20000 bytes were added to its queue and should be handled. Of these bytes, the software (SW) decided to grant 15000 bytes. Assume that in the following cycle (2), the SW receives a report of 40000 bytes. This time (in cycle 2), 40000-15000=25000 bytes need to be handled, as this is the amount of data in the queue that was not handled in cycle 1.

In summary, in this stage, the ONU might not completely have utilized the previous grant. The utilized amount is returned to its credit, meaning the ONU will not be charged for it. The amount of actual transmitted bytes is measured and decreased from the amount of granted bytes. The difference is added to the credit.

The process in adjusting request for guaranteed service step 306 is a process that assists in supporting guaranteed services. Guaranteed services are identified by a fixed amount of bandwidth (e.g. a T1 service requires 1.544 Mbit/sec, meaning 193 bytes every cycle of 1 msec) that should be granted regardless of amount requested by the user. This enables shortening the transmission delay to minimum, as the packets are transmitted at the next grant opportunity, without the need to wait for two additional cycles for report and grant procedures. In step 306, the request is compared with a value configured per user (and potentially per priority/flow), e.g. continuing the T1 example above, 193 bytes plus the required encapsulation overhead. If the request is smaller than a configurable threshold (same value), then the request is adjusted to the threshold, which is equivalent to “request=max (request, configurable threshold)”.

The limiting request by available credit step 308 is the last phase in the request calibration. The present (current) credit limits an ONU request. The credit is added with the amount allowed for an ONU to transmit in a cycle e.g. if the maximal allowed bandwidth is 100 Mbit/sec and the cycle size is 1 msec, then the bucket is increased with 12.5 Kbytes every cycle. Preferably, the well-known leaky bucket method is used as the credit method. An optimization suggested herein that reduces the computation complexity may include utilizing the fact that the cycles have a fixed length in order to add a fixed value, instead of a value multiplied by a time-dependent variable. This simplifies the leaky bucket management.

An example of credit behavior is given next Let us assume that the initial credit value is 0, and that the ONU is allowed to transmit up to 100 Mbit/sec, meaning its credit is increased by 12500 bytes every cycle of a size of 1 msec. Let us further assume that 40000 bytes entered the queue. In the first cycle, the grant is limited to 12500 bytes. In the second cycle, 27500 bytes are still pending in the queue, and the grant is given again as 12500. In the third cycle, the measurement results of the first cycle grant are known, and the unused portion of the grant is returned to the credit This means that the grant will be between 12500 and 12500+MTU (Maximal Transmission Unit). The grant in the fourth cycle will have again the same size of 2500 and 2500+MTU. The grants in the fifth and sixth cycles will just compensate for the unused portion in the third and fourth grants respectively, and their size will be 0 to MTU.

In summary, the maximal number of bytes granted to the ONU is limited by its available credit This guarantees that it will not exceed its maximal bandwidth as specified in its SLA. A leaky-bucket mechanism is preferably used to keep the credit The request is adjusted to be not larger than the bucket content.

Once the request calibration stage is completed, the method goes to the next stage, i.e. the outcome of stage 202 is now ready to be fed to the bandwidth allocation stage (stage 204). Stage 204 thereby receives ready-made values for allocation, already calibrated based on credit, and on each ONU's SLA.

In the context of the present description, “flow” is defined as the amount of bytes reported from a specific sub-queue (specific priority”), while “handling all ONU traffic as a single flow” means summing all sub-queues reports (summing all priorities). The ability to perform operations at the specific sub-queue (priority) value as opposed to the summed report value enables to handle services precisely, since priority is just a way to identify a sub-queue and can be viewed as a traffic flow of a service. In other words, maintaining variables per priority and not per single variable for the ONU, e.g. looking at the number of pending bytes for each sub-queue separately instead of looking at the number of total accumulated bytes from all sub-queues, enables to service each flow based on its specific SLA parameters.

Bandwidth Allocation Stage/Step 204

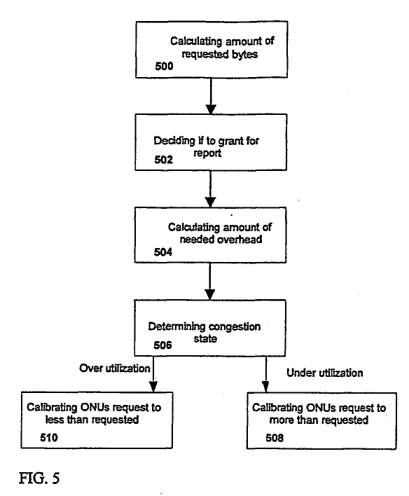

Bandwidth allocation step 204 decides the amount of bandwidth to be allocated (granted) to each ONU. The main sub-steps in this stage are shown in detail in FIG. 5.

The number of bytes required to fulfill the requests is calculated in step 500. Again, since priorities actually represent traffic flows, the sum of some priorities can be calculated separately.

The algorithm decides which ONU will receive the opportunity to transmit a report message in a next cycle in step 502. In other words, the OLT decides if the ONU should transmit a report in the next cycle. Since the report message “costs” in terms of consuming uplink bandwidth, both in the amount of bytes required to convey the message and in the required overhead as well as in additional processing in the following cycle, it is desirable to minimize the amount of report messages. One possible way to limit sending of a report message (i.e. to allow some ONUs to transmit while prohibiting others, in order to average the required algorithm processing) is to compare the available credit, e.g. the value used in step 308, with a configurable value, and to suppress the report message if the credit is too low (i.e. if the available credit is lower than the configurable value). The configurable value is typically the MTU, which in Ethernet, equals 1522 bytes. Another efficient way includes using a simple timer that allows reporting by the ONU to the OLT only once after a few cycles. The amounts of bytes allocated for the report are summed for use in the next stage.

The OLT will allow the ONU to transmit a report message in the next cycle only if it expects that it will be able later to grant the ONU based on the report that will arrive in the cycle immediately following the “next cycle”, The OLT may control the number of cycles between two report messages using a counter. This allows the OLT to minimize the amount of bytes requested for the current cycle, as well as to reduce the software computation time required in the next cycle. If the ONU is not allowed to transmit the report, then the OLT will not receive the report in the following cycle, and of course will not be required to handle the report. This will decrease the burden from the OLT.

The sum of overhead bytes is calculated, in order to predict cycle utilization, in step 504. In other words, the OLT decides if the ONU should transmit data, report, or should do both (transmit data and report) in the next cycle. The calculation must take into account the number of grants to be given in the cycle. The number of grants equals the number of ONUs that need to receive report grants, as calculated in step 502, plus the number of ONUs that need to receive a data grant, as calculated in step 504. In other words, some of the ONUs will transmit only data, some will only report, and some will do both. The amount of overhead required depends on the number of transmissions. If an ONU transmits both data and reports, then only one transmission grant is required. Naturally, an ONU must not be counted twice. Some ONUs receive more than one grant in a cycle to meet the delay requirement, based on requests arriving from specific flows. The overhead required by these ONUs needs to be added several times, based on the expected number of grants.

Note that each transmission from the ONU requires an overhead for the laser turn-on and turnoff and stabilization of the OLT reception circuitry. The sum of overheads thus depends on the number of expected transmissions.

A congestion state determination is made in step 506. This determination involves one decision if the requests from all ONUs could be entirely fulfilled, meaning that the cycle is under-utilized, and involves another decision if the requests could not be fulfilled, meaning the cycle is over-utilized. A comparison is made between the total number of bytes in the cycle and the sum of the number of bytes required for data, the number of bytes required for the report message, and the number of bytes required for the optical overhead. There are two modes of allocation: over-utilization, which means that not all of the requests can be fulfilled, and under-utilization, which means that all of the requests can be fulfilled.

The under-utilization case is handled in step 508, and the over-utilization case is handled in step 510. To make the decision between fulfilling all requests from all ONUs or not, the sum of overhead and requested bytes is compared with the available number of bytes in the cycle. Inventively and advantageously, the method provides an ability to run two completely different allocation schemes, one for each case. Each of these schemes acts differently, and optimizes the performance for the specific case.

In the case of under-utilization, ONUs are handled based on their importance factor in step 508. The requested amount of bytes is adjusted to the maximal grant quantity allowed per each ONU, until the total number of bytes yields a fully utilized grant cycle. An ONU will not receive a higher grant than its credit In the under-utilization state, the ONU receives more bytes than it requested This reduces the delay of a packet entering the ONU, until received by the OLT, because the ONU does not need to report the packet, as the OLT already granted in advance.

Inventively and advantageously, step 508 shortens the delay because the ONU does not need to wait for 2 grant cycles, and may transmit data whenever the data is pending.

An example for under-utilization allocation follows next. Let us assume a cycle of a size of 50000 bytes, and assume that four ONUs are attached to the network. Assume that each has requested 8000 bytes. Assume that the importance of each ONU equals its index, i.e. that ONU #4 is the most important and ONU #1 is the least important”. The cycle is clearly under-utilized, since the sum of requests is 32000, while the amount of available bytes is 50000. For the sake of using easy numbers, the amount of bytes added to each ONU is 2000 (in practice, 1522, the is Ethernet MTU, will be selected). In the first cycle, all ONUs receive the additional amounts of bytes, so that the grant for each will be 10000 bytes. The current grants sum is 40000 bytes, which still leaves us with an additional amount of bytes to grant. In the next cycle, the ONU with the lowest importance (ONU #1) will not receive additional bytes, but the rest will, so ONU #1 will remain with 10000 bytes, and all the others (ONUs #2-4) will have 12000. In the following cycle, ONU #1 will remain with 10000 bytes, ONU #2 will remain with 12000 bytes, and both ONU #3 and ONU #4 will have 14000 bytes. Since the grants sum is equal to the cycle size, the allocation stops. As a further addition to this example, let us repeat the last step (loop execution) when the cycle is 48000 bytes long instead of 50000 bytes. Two ONUs are eligible to receive additional bytes: #3 and #4. However, since #4 has higher importance, it will receive the additional bytes, and the final grants will be 10000, 12000, 12000, and 14000 bytes respectively.

In the case of over-utilization, all ONUs are calibrated in step 510. A calibration factor should depend on the SLA and the available credit Many calibration methods are known, and all can be used for the purposes set forth herein. A better calibration method leads to a higher fairness. An exemplary good calibration method is a method that reduces from each ONU an amount of data proportional to its importance (less importance causes more reduction). The total number of reduced bytes should be equal to the excess number of bytes that cannot be granted in the cycle. The importance order is a configuration parameter for each ONU, assigned to it when it joins the network.

In the case of an over-utilization state, the ONU receives less bytes than it has requested. Preferably, the present method starts to assign the ONUs with the highest importance order, and continues with the ONUs with lower importance order, until no more bytes are available for granting. If the amount of bytes required for all the ONUs of a single importance level cannot be honored, the ONUs are sorted based on their credit level, and those with the higher credit are honored first.

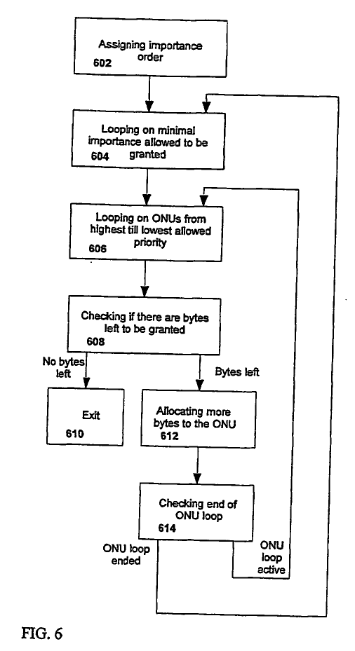

In a particular example shown in FIG. 6, each ONU is assigned an importance order in step 602. An internal variable starts to loop from the highest to the lowest importance value in step 604. An additional loop variable runs over all ONUs from highest till lower importance order in step 606. Only the ONUs with an importance order higher than the loop variable of step 604 participate in this loop. In step 608, a check is performed if the amount of available bytes to grant is sufficient, meaning larger than a predefined value. If not, the allocation cannot continue, as indicated in exit step 610. If the amount of available bytes is sufficient, then the ONU allocation is increased with a predefined value in step 612. The number of available bytes is naturally decreased by the same amount. Step 614 selects the next step to execute. If the ONU loop is not completed, the execution continues from step 606. If the ONU loop is completed, the execution returns to step 604.

In summary, the bandwidth allocation stage includes summing up all requests from all ONUs, deciding if the ONU will be allowed to transmit a report in the next cycle, summing up the overhead and deciding the allocation state.

Grant Placement Stage 206

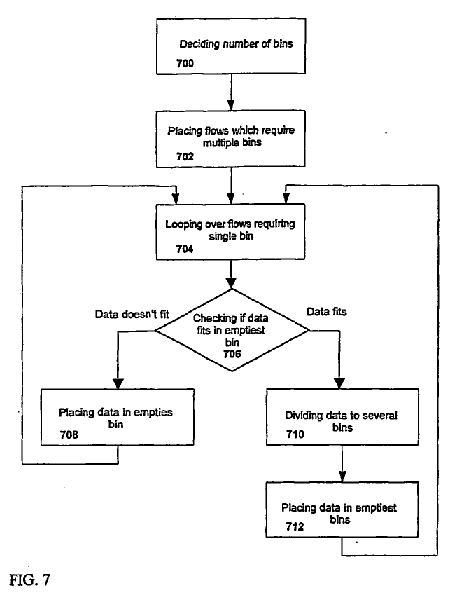

The reduction of delay in the present invention is accomplished by granting the ONU several times in a cycle. Grant placement stage/step 206 decides the location of each ONU grant during the cycle timeline. The main principle employed here is bin-packing, meaning the timeline is divided into several areas. The purpose of this division is to be able to place an ONU several times a cycle at a fixed distance, i.e. to allow the ONU to transmit with fixed delay and hence low jitter. Although the method (algorithm) of the present invention is based on cycles, some ONUs may have delay requirements smaller than the size of the cycle. In this case, an ONU receives more than one grant in a cycle. AU of these grants must be in a constant delay to provide a fixed delay. That is, if all the grants are located close to each other, the gain is lost, because the maximal delay between grants will be high. By placing all the grants at an even distance from each other on the timeline, the delay becomes constant, and low delay services can be served. By placing the ONUs that have a delay requirement smaller than a cycle length first, there is a definition of zones that are already granted. The remaining un-granted zones may be viewed as bins, each of which should be filled completely. The grant placement is based on bin placement and depicted in FIG. 7.

FIG. 7 is a flow chart of grant placement, which assigns the grant over the time axis. The number of bins is decided in step 700, the decision based on the maximal requirement from all the flows. The number of bins is preferably equal to the maximal number of grants required for an ONU in a cycle. The size of bin is preferably adjusted to the length of the cycle divided by the number of bins. All the bins have preferably an equal size. The maximal number of bytes in each bin is the total number of bytes in a cycle divided by the number of bins.

All the flows that require multiple bins are preferably placed first in step 702. Multiple bins mean that an ONU should receive several grants in a cycle, and each of these grants is located in a separate bin. In order to minimize the jitter, the same placement order should be used every cycle. For example, simply placing the flows using the flow index will guarantee a fixed order of placement. The flows that have the maximal number of grants per cycle should be placed first, followed by those with fewer grants per cycle. Several bin-packing algorithms are known, for example, first-fit, best-fit, etc. Each such packing algorithm can be used in the present invention. However, for best performance, the preferable packing algorithm includes sorting the requests based on their length, and then first-fitting the sorted output.

The rest of the flows that require a single bin are handled sequentially in step 704. A loop is run over all these, again preferably in a fixed order on each cycle. A check is run to see if the amount of data to be granted for the flow fits in the emptiest bin in step 706. If it can fit inside the emptiest bin, or even if the bin will slightly overflow, as allowed by a configuration parameter, then the granted amount of data is added and placed in the bin in step 708.

The execution then continues with the next ONU in step 706. If the bin overflows too much in check 706 (overflow means jitter, i.e. variance of distance between two grants), the grant is divided into several fragments, until the emptiest bins are filled, because the grant is divided to be placed in several bins (the n^{th} emptiest bin should be filled, when n is the number of fragments) in step 710. The data is place in the emptiest bins in step 712. The execution then continues with the next ONU in step 706. The operation is completed when all grants are placed. In other words, the grants are placed in a bin. If the grant is too big to fit in the emptiest bin, then an overflow state is declared. In this state, the grant must be split into several grants, each to be placed in a different bin, where each bin will not exceed its maximal occupancy.

The following example illustrates the process in the paragraph above. Let us use the following numbers: the cycle is 1 msec long, meaning 125000 bytes. An ONU needs to transmit 1000 bytes every 0.25 msec. This means that 4 bins should be defined, each with a size of 31250 bytes. The grants for the ONU with the smallest delays are placed in each bin, leaving 30250 bytes available in each one. If two ONUs should be placed, one with 40000 bytes and the other with 60000 bytes, the placement sequence begins with placing the grant of the ONU with 60000 bytes. However, since it cannot fit inside the bin, it is divided into two grants: 30250 and 60000-30250=29750 bytes. Both are placed respectively in the first two bins. The second ONU is divided also into two grants 30250 and 40000-30250=9750 bytes. Both are placed respectively in the last two bins.

The invention has now been described with reference to specific embodiments. Other embodiments will be apparent to those of ordinary skill in the art. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for dynamic bandwidth allocation (DBA) in a passive optical network that includes a plurality of optical network units (ONUs) coupled to an optical line terminal (OLT), the method comprising the steps of: by the OLT, in each given cycle:
a) calibrating requests issued by each of the ONUs to obtain respective calibrated requests;
b) allocating a bandwidth amount to each ONU based on said calibrated requests using an allocation scheme selected from the group consisting of an under-utilization allocation scheme and an over-utilization allocation scheme; and
c) based on said bandwidth allocation, granting the ONUs a second plurality of constant delay grants per each said cycle;
whereby said granting facilitates a tight jitter/delay guarantee and high fairness and eliminates grant loss.

2. The method of claim 1, wherein in each said cycle, each said ONU issues a report to said OLT, and wherein said step of calibrating requests includes limiting said requests by an available credit.

3. The method of claim 2, wherein said limiting of said requests by an available credit is preceded by the following: for each said ONU:
i. reading a requested amount of bytes that represent a current report value of said report;
ii. estimating a queue occupancy by updating said report value based on grants issued by the OLT in an immediately preceding cycle;
iii. by the OLT, using said available credit to account for said updated report value; and
iv. adjusting each said request to achieve a guaranteed service level.

4. The method of claim 1, wherein said step of allocating bandwidth using an under-utilization allocation scheme includes assigning a grant based on a respective ONU request and on service level agreement (SLA) parameters based on a respective ONU importance.

5. The method of claim 1, wherein said step of allocating bandwidth using an over-utilization allocation scheme includes calibrating all said ONUs to provide a grant size that will fairly satisfy all service level agreements (SLAs) of all said ONUs, thereby providing high uplink utilization.

7. The method of claim 4, wherein said assigning a grant based on a respective importance factor includes adding an additional amount of bytes to a requested amount of bytes, said additional amount correlated with an ONU importance.

8. The method of claim 6, wherein said assigning a grant based on a respective importance factor further includes:
a) running a first loop from a lowest to a highest said importance factor, to provide an input variable;
b) using said input variable, running a second loop over all said ONUs, starting with said highest importance ONU, to provide an indication if a grant can be increased; and
c) if a respective ONU grant can be increased, increasing said respective ONU grant with a configurable byte amount

9. In an Ethernet passive optical network (EPON), a method for dynamically allocating bandwidth to a plurality of optical network units (ONUs) that are granted grants by an optical line terminal (OLT) in response to requests, the method comprising the steps of:
a) per each grant cycle, responsive to the requests of each ONU, determining an uplink utilization state that includes a state selected from the group of under-utilization and over-utilization; and
b) running independently a bandwidth allocation scheme correlated with said uplink utilization state, said bandwidth allocation scheme selected from the group of respectively an under-utilization allocation scheme and an over-utilization allocation scheme.

10. The method of claim 8, wherein said step of determining an uplink utilization includes comparing a sum of all said requests with a size of said cycle, whereby said under-utilization occurs when said sum of all requests is smaller than said cycle size.

11. The method of claim 9, wherein in a case of said under-utilization each of said ONUs is associated with an importance parameter, and wherein said step of running an under-utilization scheme includes handling said ONUs based on each said ONU respective importance.

12. The method of claim 10, wherein said handling of said ONUs based on their respective importance further includes determining a grant size per each said cycle by adding a given amount of bytes to each said ONU, said addition of bytes based on said respective importance.

13. The method of claim 11, wherein said determining a grant size per each said cycle by adding a given amount of bytes to each said ONU base on said respective importance further includes:
a) running a first loop from a lowest to a highest said importance factor, to provide an input variable;
b) using said input variable, running a second loop over all said ONUs, starting with a highest importance ONU, to provide an indication if a grant can be increased, and;
c) if a respective ONU grant can be increased, increasing said respective ONU grant with a configurable byte amount

14. The method of claim 10, further said step of running an under-utilization scheme further includes stopping said handling after a cycle in which a said grant equals said cycle size.

15. In an Ethernet passive optical network (EPON) that includes a plurality of optical network units (ONUs) interacting with an optical line terminal (OLT), a method for dynamically allocating bandwidth by the OLT to the ONUs in an under-utilization state of a cycle, comprising the steps of:
a) determining the importance of each ONU; and
b) allocating bandwidth based on said importance.
